(19) United States
(12) Patent Application Publication
(10) Pub. No.: US 2013/0136032 A1
(43) Pub. Date: May 30, 2013

(54) METHOD AND APPARATUS FOR MANAGING COMMUNICATIONS OF A PHYSICAL NETWORK ENTITY

(71) Applicants: Catalin Meirosu, Stockholm (SE); Said Soulhi, Saint-Constant (CA)

(72) Inventors: Catalin Meirosu, Stockholm (SE); Said Soulhi, Saint-Constant (CA)

(73) Assignee: TELEFONAKTIEBOLAGET LM ERICSSON (PUBL), Stockholm (SE)

(21) Appl. No.: 13/698,260

(22) PCT Filed: May 19, 2010
(86) PCT No.: PCT/EP10/03083

§ 371 Date: Feb. 18, 2013

(51) Int. Cl. H04W 40/00; H04W 40/24; H04W 76/02; H04W 24/00

(52) U.S. Cl. CPC H04W 40/00; H04W 24/00; H04W 40/24; H04W 76/02
USPC 370/254; 370/328; 370/329

(57) ABSTRACT

The invention relates to a method for managing communications of a physical network entity in an arrangement of physical network entities. The method comprises managing (101) communications of the physical network entity in the arrangement of physical network entities using a virtual management stratum, the virtual management stratum being associated with the physical network entity.

### TECHNICAL FIELD

The present invention relates to communication networks.

### BACKGROUND

In order to support transmissions of different services such as audio data or video data towards different recipients residing in e.g. different countries, efficient communication networks are necessary. An efficient horizontally layered architecture is e.g. described in “Control Servers in the Core Network”, Ericsson Review No. 4, 2000. By way of example, the layered network architecture as e.g. introduced with release for of the 3GPP (3rd Generation Partnership Project) specification comprises three distinct layers: an application layer, a network control layer and a connectivity layer. The application layer supports end-user applications and may be implemented in mobile stations or application servers in the network. The application layer may interface with the network layer via a set of application program interfaces (API) which enables designing and implementing different services and applications. The network control layer supports communicating services across e.g. different types of networks such as circuit-switched domain networks based on the GSM standard using e.g. an ISDN-related technology or packet-switched networks employing e.g. the GPRS technology. The connectivity layer is a transport layer capable of transporting any type of service via e.g. voice, data and multimedia streams.

According to the UMTS (Universal Mobile Telecommunications System) technology, the control layer may comprise a mobile switching center (MSC) handling control layer functions at a border between an access network and a core network. The communication between the access network and the MSC server may be performed upon the basis of RANAP messages (Radio Access Network Application Protocol). The network control layer according to the UMTS technology may further comprise a transit switching center (TSC) managing communications between the core network and another network such as e.g. ISDN (Integrated Services Digital Network) or PSTN (Public Switched Telephone Network) network. The MSC and the TSC may communicate via gateway control protocol (GCP) messages with a respective media gateway (MGW) or mobile MGW (M-MGW) arranged in the connectivity layer for managing data transmissions. Typically, a MGW receives data from a communication entity, such as a mobile station or an application server, via the access network and e.g. converts the ATM (Asynchronous Transfer Mode) data streams into IP (Internet Protocol) data streams for further transport.

Another emerging communication technology for delivering multimedia services across fixed and mobile access networks is provided by the IP Multimedia Subsystem (IMS) technology. The network architecture according to IMS comprises a service layer corresponding to the aforementioned application layer, a control and connectivity layer corresponding to the aforementioned network control layer and an access layer corresponding to the aforementioned connectivity layer. In particular, the control and connectivity layer may comprise call session control functions (CSCF) forming central nodes for the provision of the SIP signaling (SIP: Session Initiation Protocol). The control and connectivity layer further comprises a MGCF (Media Gateway Control Function) communicating with the CSCF via SIP messages and with media gateways arranged within the access layer using media gateway messages according to e.g. the H.248 protocol. The control and connectivity layer may further comprise a MRF (Media Resource Function) providing media services e.g. in a home network.

A further emerging communication technology is the Evolved Packet System (EPS) as defined by the 3GPP standards organization. One of the communication technologies deployed within the context of the EPS is the LTE access technology (LTE: Long Term Evolution). The EPS comprises a MME (Mobility Management Entity) forming a control-node responsible for signaling and selecting a serving gateway (SGW) which routes and forwards user data packets is provided. The MME and the SGW are parts of an Evolved Packet Core (EPC) which comprises further elements such as SGSN (Serving GPRS Support Node) or PGW (Packet Data Network Gateway). In particular, the MME is the device that may host, according to the 3GPP TS 23.401 standard, the following functions: NAS signaling (NAS: Non-Access Stratum), NAS signaling security, AS security control, Inter-CN (CN: Core Network) node signaling for mobility between 3GPP access networks, idle mode UE (User Entity) reachability which may include control and execution of paging retransmission, tracking area list managements, e.g. for a UE in an idle and an active mode, PDN GW and serving GW selection (GW: Gateway), MME selection for handovers with MME change, SGSN selection for handovers to 2G or 3G 3GPP access networks, roaming, authentication, bearer management functions including dedicated bearer establishment, and support for a TWS message transmission.

An important aspect in emerging communication networks, in particular in UMTS, GSM (Global System for Mobile Communications), WCDMA (Wide-Band Code Division Multiplexes) or LTE networks, is the mobility management. Usually, a user entity (UE), e.g. a mobile device, is associated with a physical mobility encore such as MME for mobile communications. An approach to support the mobility management is defined e.g. in the 3GPP TS 23.401 standard, according to which a MME pool area is defined within which the UE may be served without a need to change the serving MME. However, the capabilities of the MMEs are rather limited with respect to the mobility management. Another approach to support the mobility management is a virtual network architecture as described in “Network virtualization architecture: Proposal and initial prototype”, VISA 09, Aug. 17, 2009, Barcelona, Spain, ACM 978-1-60558-595-6/09/08. The virtual network architecture replaces the physical network architecture, whereby physical network entities are replaced by virtual network entities. However, the virtual networks require a full virtualization of the physical network entities to provide a virtual network infrastructure, which may tend to be expensive.

### SUMMARY

The invention is based on the finding that the mobility management capability of physical network entities may be improved when the physical network entities communicating over a communication network are provided with an additional management layer explicitly managing communications of the physical network entities. The additional management layer may be e.g. arranged on top of e.g. an OSI (Open System Interconnect) protocol stack used for communications. Such additional management layer may be formed by a virtual management stratum dedicated for managing communications of the physical network entity associated therewith. Thus, the virtual management stratum does not virtualize the complete functionality of the physical network entity. Rather, the virtual management stratum comprises the layer functionality which coordinates communications of the physical network entity in the communication network. Therefore, the physical network infrastructure may still be used for enhanced mobile communications.

According to an aspect, the invention relates to a method for managing communications of a physical network entity in an arrangement of physical network entities. The method comprises managing communications of the physical network entity in the arrangement of physical network entities using a virtual management stratum, the virtual management stratum being associated with the physical network entity. The virtual management stratum may comprise a collection of network functions which may be related to each other in particular in a distributed network scenario. By way of example, the virtual management stratum may comprise a full functionality or a part functionality of protocol layers of the OSI stack. The virtual management stratum may comprise the functionality of the third or fourth layer of the OSI stack and a part of the functionality of the upper layers, e.g. of the layers 5, 6 or 7 of the OSI stack. The functionality of the virtual management stratum may be specific to a service or to an application, so that only the functionality of the layers of the OSI stack may be implemented within the scope of the virtual management stratum to support the related communications.

According to an embodiment, the managing communications may comprise exchanging a communication message between the virtual management stratum and another virtual management stratum which is associated with another physical network entity of the arrangement of physical network entities. The communication message may be e.g. a communication message or a payload message exchanged between the physical network entities. Thus, the virtual management strata communicate with each other in order to establish a physical communication between the physical network entities for exchanging the communication message. Clearly, the communication message may be transmitted, processed and evaluated by the physical network entities.

According to an embodiment, the virtual management stratum may receive a communication message, determine a physical network entity of the arrangement of physical network entities to which the communication message pertains, or randomly select a physical network entity from the arrangement of physical network entities to determine a physical network entity for forwarding, e.g. transmitting, the communication message. Further, the virtual management stratum may initiate a forward of the communication message towards the determined physical network entity. In order to determine the physical network entity to which the communication message pertains, the virtual management stratum may resolve a network address of that physical network entity. Alternatively, the network address of the physical network entity may randomly be selected in order to determine the physical network entity towards which the communication message may be forwarded. In order to initiate the forward of the communication message towards the determined physical network entity, the virtual management stratum may indicate to the physical network entity that the communication message may be transmitted towards the determined physical network entity. In response thereto, e.g. a transmitter of the physical network entity transmits the communication message over a communication network towards the determined physical network entity.

According to an embodiment, the virtual management stratum may receive a communication message requesting a transmission of certain information, e.g. user context, towards a user entity, determine a physical network entity in the arrangement of physical network entities which has the certain context, and initiate a forward of the communication message towards the determined physical network entity to initiate a transmission of the certain information towards the user entity. In order to determine the physical network entity, e.g. a network address of the physical network entity may be retrieved, wherein the forwards of the communication message may be initiated as mentioned above.

According to an embodiment, the virtual management stratum may maintain connectivity between the physical network entity and another physical network entity in the arrangement of physical network entities. In order to maintain the connectivity, the virtual management stratum may maintain a control channel between a virtual management stratum of the other physical network entity in the arrangement of the physical network entities. The arrangement of the physical network entities may be a pool of physical network entities such as a pool of MMEs.

According to an embodiment, the virtual management stratum may initiate a transmission of a communication message towards another physical network entity in the arrangement of physical network to request a transmission of certain information towards the physical network entity. In order to initiate the transmission of the communication message, the virtual management stratum may retrieve a network address of the other physical network entity.

According to an embodiment, the virtual management stratum may initiate a transmission of a communication message towards another physical network entity in the arrangement of physical network entities, the communication message comprising network information indicating at least one of: a network load or an availability of the physical network entity. Thereby, the information concerning the available physical network resources may be distributed in the arrangement of the physical network entities.

According to an embodiment, the virtual management stratum may determine a physical network entity in the arrangement of physical network entities towards which certain information is to be transmitted upon the basis of a complexity measure, and initiate a transmission of the certain information towards the determined physical entity. The complexity measure may relate to available network resources such as available bandwidth or available time slots. However, the complexity measure may also relate to a CPU load of the physical network entity. Generally, the complexity measure may relate to costs in terms of bandwidth, data rate etc. which are associated with transmitting the certain information towards the physical network entity.

According to an embodiment, the arrangement of physical network entities may comprise a network control node, a network management node and a user entity, the network control node communicating with the network management node, the network management node managing communications of the user entity, the virtual management stratum being associated with the network management node, wherein the virtual management stratum may manage communications of the network management node with the network control node or with the user entity.

According to an embodiment, the arrangement of physical network entities may comprise a network control node, a network management node and a user entity, the network control node communicating with the network management node, the network management node managing communications of the user entity, the virtual management stratum being associated with the network control node, wherein the virtual management stratum may maintain a first communication link between the network control node and a first network management node of the arrangement of physical network entities, and maintain a second communication link between the network control node and a second network management node of the arrangement of physical network entities, the second communication link forming a stand-by communication link for the first communication link. The second communication link may thus enable communications in the arrangement of the physical network entities when the first communication link is interrupted, e.g. when the first network management node is out of order.

According to an embodiment, the arrangement of physical network entities may comprise a network control node, a network management node and a user entity, the network control node communicating with the network management node, the network management node managing communications of the user entity, the virtual management stratum being associated with the user entity, wherein the virtual management stratum may initiate a transmission of an attach request towards a virtual management stratum of the network control node to request an establishment of a communication link over a communication network.

According to an embodiment, the virtual management stratum may locally generate locally generating a global unique temporary identity (GUTI).

According to an aspect, the invention relates to a physical network entity for communicating in an arrangement of physical network entities. The physical network entity comprises a processor being configured to provide a virtual management stratum associated with the physical network entity, the virtual management stratum being configured to manage communications of the physical network entity in the arrangement of physical network entities. In order to provide the virtual management stratum, the processor may execute a computer program or a process realizing the virtual management stratum.

According to an embodiment, the virtual management stratum may comprise a virtual entry point entity for communicating with another physical network entity of the arrangement of physical network entities. The virtual entry point entity may form an interface for communications between virtual management strata of different physical network entities.

According to an embodiment, the virtual management stratum may comprise a virtual mobility manager entity for identifying another physical network entity holding certain information, or for transmitting certain information towards another physical network entity in the arrangement of physical entities.

According to an embodiment, the virtual management stratum may comprise a virtual topology manager entity for maintaining connectivity between the physical network entity and another physical network entity.

According to an embodiment, the virtual management stratum may comprise a virtual mobility optimization entity for determining another physical network entity in the arrangement of physical network entities towards which certain information is to be transmitted upon the basis of a complexity measure, and for initiating a transmission of the certain information towards the determined physical entity.

According to an embodiment, the physical network entity may be a network management entity managing communications of a user entity in the arrangement of physical network entities.

According to an embodiment, the arrangement of physical network entities may comprise a network control node, a network management node and a user entity, the network control node communicating with the network management node, the network management node managing communications of the user entity, the physical network entity being the network control entity, wherein the virtual management stratum may comprise a virtual mobility proxy entity for managing communications between the network control entity and the network management node.

According to an embodiment, the arrangement of physical network entities may comprise a network control node, a network management node and a user entity, the network control node communicating with the network management node, the network management node managing communications of the user entity, the physical network entity being the user entity, the virtual management stratum being configured to initiate a transmission of an attach request towards a virtual management stratum of the network control node, the attach request requesting an establishment of a communication link over a communication network.

According to an embodiment, the processor may be configured to execute a computer-implemented process to provide the virtual management stratum.

According to an embodiment, the processor being configured to execute a computer program for executing any of the method described herein.

Further embodiments of the physical network entity or of processor's functionality are derivable from the steps of the method for managing communications.

The physical network entity referred to herein may be any network node or user entity according to e.g. the UMTS technology, the IMS technology or the EPC technology. By way of example, the physical network entity referred to herein may form a network control node, e.g. eNodeB, or a network management node, e.g. a Serving Gateway (SGW) or a Media Gateway (MGW) or a Packet Data Network Gateway (PGW) or a SGSN (Serving GPRS Support Node), or a MME (Mobility Management Entity), or a MSC (Mobile Switching Center), or a MGCF (Media Gateway Control Function), or a user entity (UE).

### BRIEF DESCRIPTION OF THE DRAWINGS

Further embodiments will be described with reference to the following figures, in which:

FIG. 1 shows a diagram of a method for managing communications of a physical network entity according to an embodiment;

FIG. 2 shows a block diagram of a physical network entity according to an embodiment;

FIG. 3 shows an arrangement of physical network entities communication system according to an embodiment;

FIG. 4 shows an arrangement of physical network entities according to an embodiment;

FIG. 5 shows an arrangement of physical network entities according to an embodiment; and

FIG. 6 shows an arrangement of physical network entities according to an embodiment.

### DETAILED DESCRIPTION

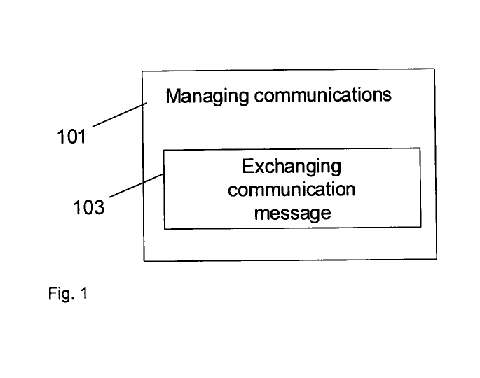

FIG. 1 shows a diagram of a method for managing communications of a physical network entity in an arrangement of physical network entities. The method comprises managing 101 communications of the physical network entity in the arrangement of physical network entities using a virtual management stratum which is associated with the physical network entity. By way of example, the step of managing communications may comprise exchanging 103 a communication message between the virtual management stratum and another virtual management stratum.

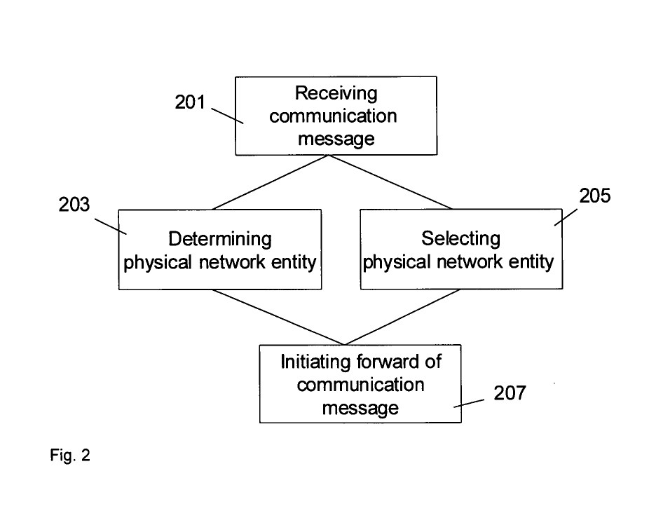

FIG. 2 shows a block diagram of a method for managing communications of a physical network entity, wherein the virtual management stratum may perform the steps of receiving 201 a communication message, determining 203 a physical network entity towards which the communication message pertains, e.g. to which the communication message is addressed, or e.g. randomly selecting 205 a physical network entity to determine a physical network entity to forward the communication message. The method may further comprise initiating 207 a forward, e.g. a transmission, of the communication message, e.g. transmitting the communication message towards the determined physical network entity by the virtual management stratum.

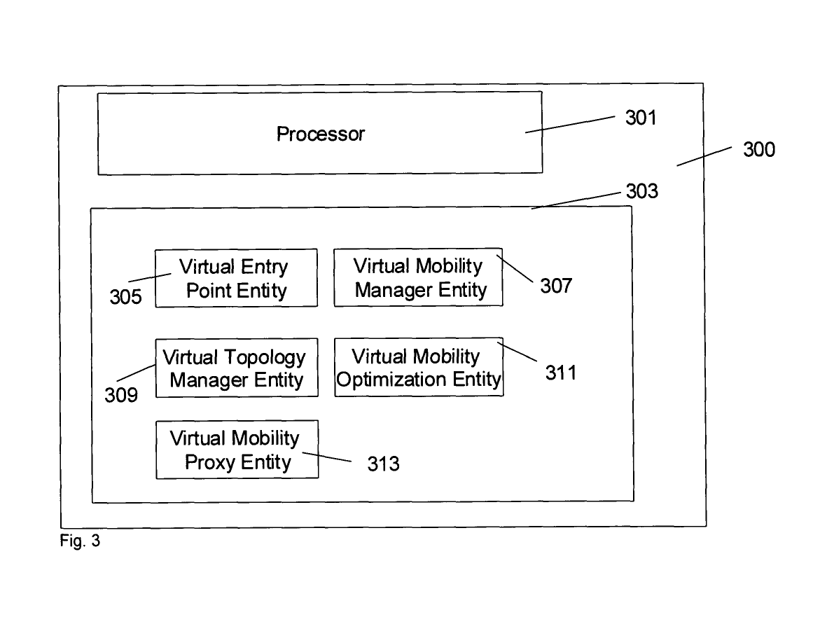

FIG. 3 shows a block diagram of a physical network entity 300 comprising a processor 301 which is configured to provide a virtual management stratum 303 associated with a physical network entity which is not shown in FIG. 3. The virtual management stratum 303 may comprise a virtual entry point entity 305 and/or a virtual mobility manager entity 307 and/or a virtual topology manager entity 309 and/or a virtual mobility optimization entity 311. According to an embodiment, the virtual management stratum 303 may comprise a virtual mobility proxy entity 313.

The physical network entity 300 shown in FIG. 3 may be e.g. a network control entity or a network management entity or a user entity (UE).

According to an embodiment, the physical network entity 300 shown in FIG. 3 may be a MME forming an embodiment of a network management entity. In this case, the virtual entry point entity 305 realizing a Virtual Entry Point Function may form a point of connectivity between the MME and one or more network control entities such as eNodeBs. The virtual entry point entity 305 may receive signaling requests from a UE, which may be relayed by the eNodeB. Furthermore, the virtual entry point entity 305 may forward the requests to the physical MME device identified by the virtual mobility manager entity 307 as holding e.g. a particular UE context concerned by the request. For an incoming request from an unknown UE context, an optional translation algorithm may select one of the members of the virtual MME pool at random. However, the selection may be augmented based on a weighted round robin allocation. It then forwards the request to this MME for handling.

The virtual mobility manager entity 307 realizing a Virtual Mobility Manager Function may identify the physical device holding a user context at a given moment in time. The virtual mobility manager entity 307 may also perform a move of the user context between physical MMEs in case it is triggered by the a virtual mobility optimization entity 311.

The virtual topology manager entity 309 may manage communications for the MME farm or pool. By way of example, the virtual topology manager entity 309 may maintain the connectivity between the MMEs in one operator domain and provide functionality for quickly searching, for example based on DHTs, for user contexts within the farm. The virtual topology manager entity 309 may also propagate information about load, availability, etc. between the MMEs.

The virtual mobility optimization entity 311 realizing a Virtual Mobility Optimization function may identify a need for a UE context move operation, based on a set of criteria that may include signaling delays, load characteristics on the MME, etc. A move could also be triggered in case a shutdown signal is received via the management interface. For a UE context move operation, the virtual mobility optimization entity 311 may determine a destination MME device, based on a set of criteria that may include signaling delays or load characteristics on the MME, and on specific objectives or constraints, such as minimizing transport cost, minimizing signaling delays, etc.

According to an embodiment, the physical network entity 300 shown in FIG. 3 may be an eNodeB forming an embodiment of a network control entity. The virtual management stratum in the eNodeB may contain a virtual mobility proxy entity 313 realizing a Virtual Mobility Proxy. The virtual mobility proxy entity 313 may be in charge of managing the connection between the eNodeB and the virtual entry point entity 305 in the MME virtual management stratum. By way of example, a hot standby connection may be configured to a secondary virtual entry point entity realizing a Virtual Entry Point function in another MME. Thus, the traffic between the eNodeB and the virtual management strata of the MMEs may addressed to the primary virtual entry point entity, e.g. the virtual entry point entity 305. Other mechanisms, for example the HIP approach, may be used instead of a connection to the secondary virtual entry point entity in order to provide resiliency.

According to an embodiment, the physical network entity 300 shown in FIG. 3 may be a UE. In order to provide to provide an unambiguous identification of the UE, the GUTI (Globally Unique Temporary Identity) approach as defined in the 3GPP TS 23.401 standard may be deployed, as described in the following:

The purpose of the GUTI is to provide an unambiguous identification of the UE that does not reveal the UE or the user's permanent identity in the Evolved Packet System (EPS). It also allows the identification of the MME and network. It can be used by the network and the UE to establish the UE's identity during signaling between them in the EPS. Conventionally, the GUTI has two main components:
one that uniquely identifies the MME which allocated the GUTI; and
one that uniquely identifies the UE within the MME that allocated the GUTI.

Within the MME, the mobile may be identified by the M-TMSI. In addition, the Globally Unique MME Identifier (GUMMEI) may be constructed from the MCC, MNC and MME Identifier (MMEI), wherein the MMEI may be constructed from an MME Group ID (MMEGI) and an MME Code (MMEC). Thus, the GUTI may be constructed from the GUMMEI and the M-TMSI. For paging purposes, the UE may be paged with the S-TMSI may be constructed from the MMEC and the M-TMSI. Preferably, the MMEC is unique within the MME pool area and, if overlapping pool areas are in use, unique within the area of overlapping MME pools.

The GUTI may be used to support subscriber identity confidentiality, and, in the shortened S-TMSI form, to enable more efficient radio signaling procedures such as paging and Service Request.

The format and size of the GUTI may be as follows:

<GUTI> = <GUMMEI><M-TMSI>,

where <GUMMEI> = <MCC><MNC><MME Identifier
and <MME Identifier = <MME Group ID><MME Code>

Furthermore, the MCC and MNC may have the same field size as in earlier 3GPP systems, the M-TMSI may be of 32 bits length, the MME Group ID may be of 16 bits length, and the MME Code may be of 8 bits length.

According to an embodiment, the virtual management stratum in the UE may support a V-GUTI (Virtual GUTI) as defined as below:

<V-GUTI> = <V-GUMMEI><M-TMSI>,

where <V-GUMMEI> = <MCC><MNC><MME Virtual Identifier

The MCC and MNC may have the same field size as in earlier 3GPP systems. Furthermore, the M-TMSI may be of 32 bits length, as in existing 3GPP systems. MME Virtual Identifier may be of 24 bits length which provides for backwards compatibility with existing 3GPP systems.

The virtual management stratum in the UE may automatically generate a local V-GUMMEI before performing a network attachment procedure. This identifier may then be replaced by one that has system-wide validity during the attach procedure. The new identifier is supplied by the eNodeB.

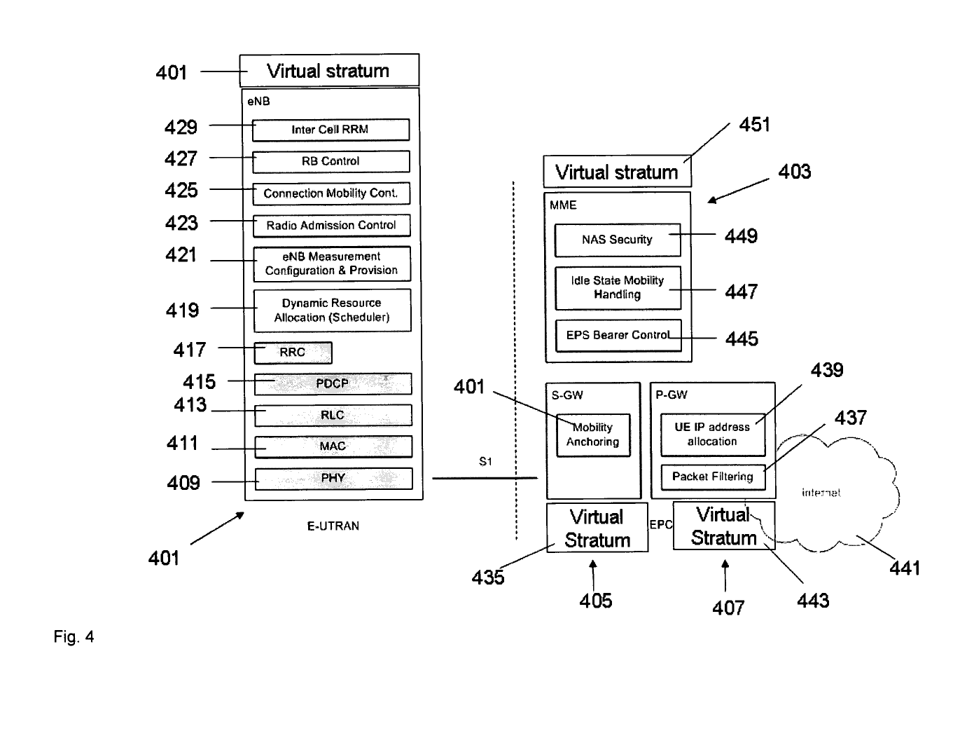

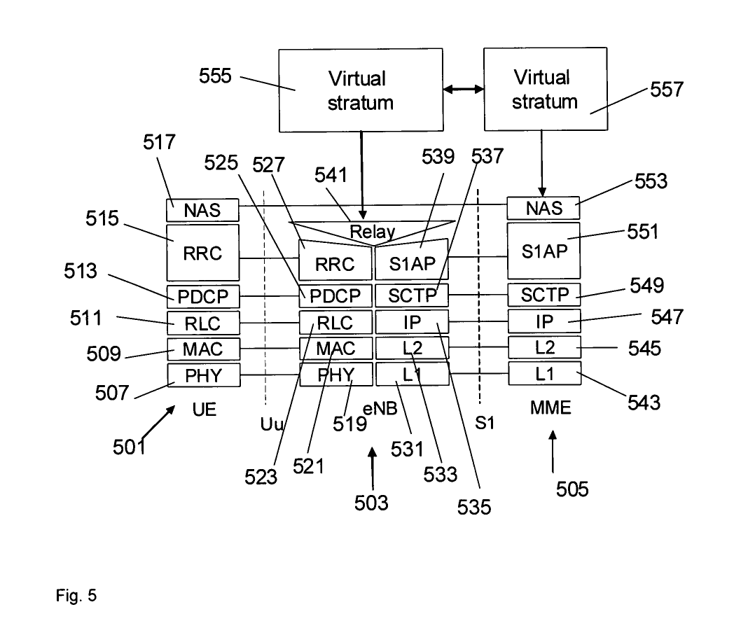

FIG. 4 shows an arrangement of physical network entities comprising an eNodeB 401 forming an embodiment of a network control node, a MME 403 forming an embodiment of a network management node, a S-GW 405 forming an embodiment of a network management node, a P-GW 407 forming an embodiment of a network management node.

The eNodeB 401 may be arranged according to a layered communication scenario comprising a physical layer 409 (PHY), a medium access layer (MAC) 411, a radio link control (RLC) layer 413, a packet data convergence protocol (PDCP) layer 415, a radio resource control layer (RRC) 417. Optionally, a dynamic resource allocation or scheduler 419, an eNodeB measurement configuration and provision 421, a radio admission control 423, a connection mobility control 425, a RB control 427 and an intercell RRM 429 may be provided in accordance with the E-UTRAN approach. Additionally, the eNodeB 401 may comprise a virtual management stratum 431 managing communications of the eNodeB 409.

The eNodeB 401 communicates e.g. via a S1 interface with the S-GW 405 comprising a mobility anchoring 433. Additionally, the S-GW 405 comprises a virtual management stratum 435 managing communications of the S-GW 405. The S-GW 405 may correspond to the EPC technology, according to which the P-GW 407 may comprise packet filtering 437 and user entity (UE) IP address allocation 439 (IP: Internet Protocol). The P-GW 407 may communicate via a communication network 441, e.g. internet. Additionally, the P-GW 407 may comprise a virtual management stratum 443 for managing communications of the P-GW 407.

The MME 403 may comprise a PS bearer control 445, an idle state mobility handling 447 and an NAS security 449 (NAS: Non-Access Stratum). The MME 403 further comprises a virtual management stratum 451 managing communications of the MME 403.

FIG. 5 shows an arrangement of physical network entities comprising a user entity (UE) 501, a eNodeB 503 and a MME 505. By way of example, the entities 501, 503 and 505 may be associated with virtualized mobility management strata for future 3GPP networks.

The UE 501 may comprise a physical layer 507, a MAC layer 509, a RLC layer 511, a PDCP layer 513, a RRC layer 515 and an NAS functionality 517.

The eNodeB 503 may comprise a physical layer 519, a MAC layer 521, a RLC layer 523, a PDCP layer 525 and a RRC layer 527. Furthermore, the eNodeB 503 may comprise a L1 layer 531, a L2 layer 533, an IP layer 535, a SCTP layer 537 and a S1AP layer 539. Furthermore, a relay functionality 541 may be provided.

The MME 505 may comprise a L1 layer 543, a L2 layer 545, an IP layer 547, a SCTP layer 549, a S1AP layer 551 and a NAS functionality 553.

By way of example, the eNodeB 503 may be associated with or comprise a virtual management stratum 555 managing communications of the eNodeB 503. By way of example, the virtual management stratum 555 provides a virtualization strata function realizing e.g. a virtual mobility proxy. Correspondingly, the MME 505 may be associated with a virtual management stratum 555 providing a virtualization strata function realizing e.g. a virtual entry point, a virtual mobility manager, a virtual topology manager or a virtual mobility optimization. THE UE may or may not be provided with a virtual management stratum.

As depicted in FIG. 5, the virtual management stratum 555 may communicate with the eNodeB 503 and may communicate with the virtual management stratum 557 of the MME 505. Nevertheless, the UE 501 may communicate with the eNodeB 503 via the Uu interface, according to which corresponding layer communicate with each other e.g. in a peer-to-peer fashion. Furthermore, the eNodeB 503 may communicate with the MME 505 via the S1 interface 505.

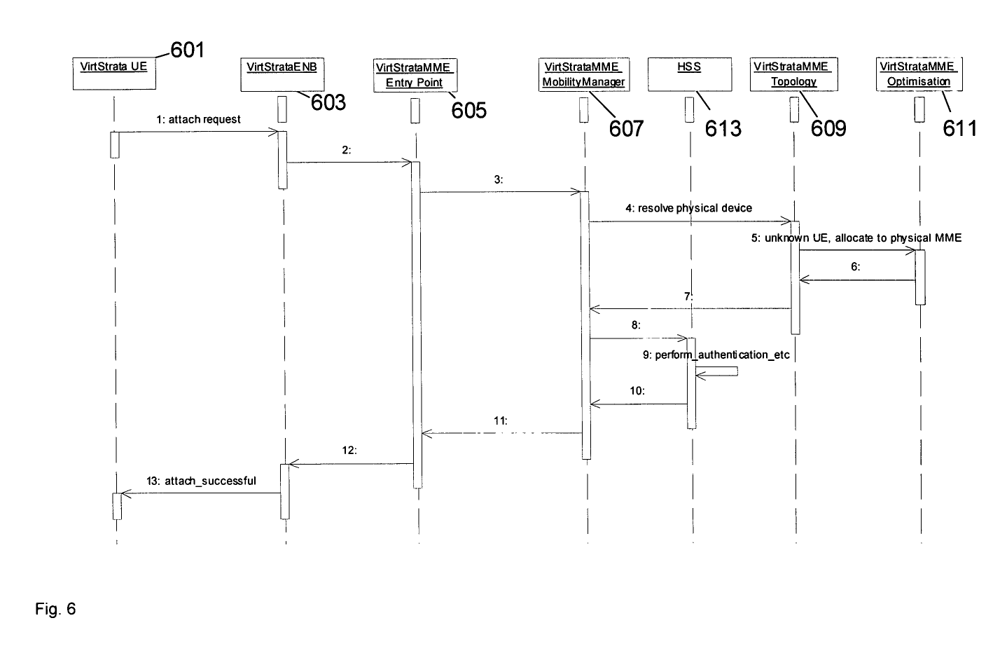

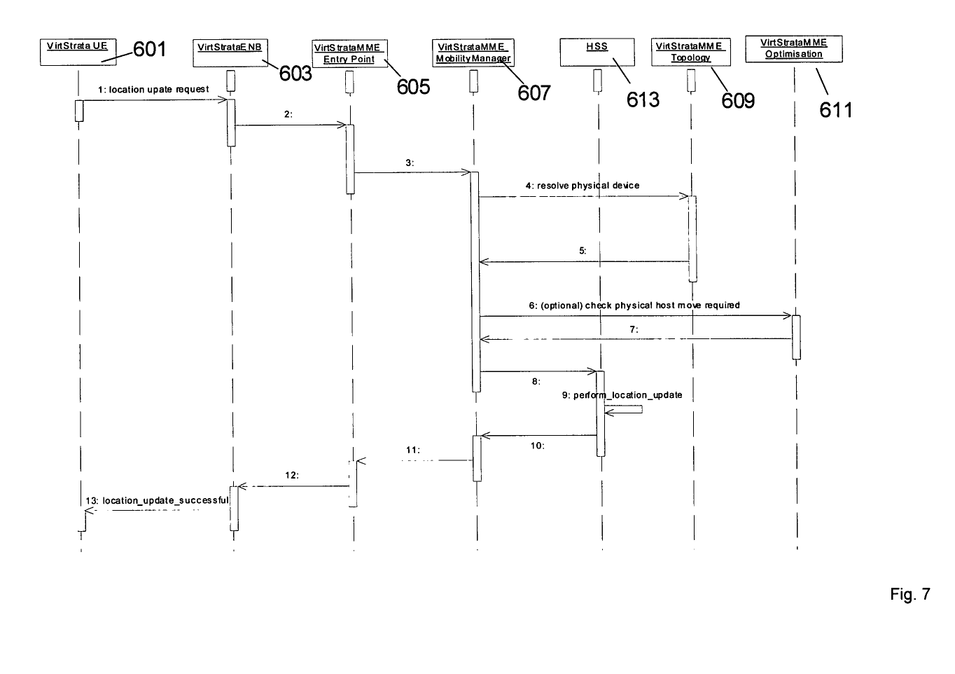

FIG. 6 shows an attach procedure with a virtualized mobility management according to an embodiment, in an arrangement in which a virtual management stratum 601 associated with a UE, a virtual management stratum 603 associated with an eNodeB, a virtual entry point entity 605 associated with a virtual management stratum of a MME, a virtual mobility manager entity 607 associated with the virtual management stratum of the MME, a virtual topology manager entity 609 for the MME form of the virtual management stratum of the MME, a virtual mobility optimization entity 611 of the virtual management stratum of the MME and a HSS 613 are present. By way of example, the virtual management stratum 601 may initiate a transmission of an attach request towards the virtual management stratum 603 in step 1.

In FIG. 6, a simplified attach procedure is depicted to exemplarily highlight only the steps involving the virtual management strata. The further steps may be performed according to e.g. the 3GPP standard. In FIG. 6, the vertical lines denote virtual network functions, i.e. strata, which are distributed along all the devices of the same type within the network. For example, the steps 4 and 8 of the signaling diagram may be performed by the same virtual network function, although the messages may be initiated by two different physical entities, i.e. devices.

In step 4 of the signaling sequence in FIG. 6, the virtual mobility manager entity 607 (VirtStrataMMEMobilityManager) queries the virtual topology manager entity 609 (VirtStrataMMETopology), which may be located on the same physical device, and asks it to identify whether the UE that requested an attach is already known to the network. The virtual topology manager entity 609, based on e.g. an index built with DHT tables (DHT: Distributed Hash) which are known to distribute and retrieve information. Thus, it may quickly be determined whether the UE is known to the network or not.

With reference to FIG. 6, the UE may be unknown to the network, step 5. In this case, the a virtual topology manager entity 609 (VirtStrataMMETopology) may asks the virtual mobility optimization entity 611 (VirtStrataMMeOptimisation) to determine which physical network entity may be optimum in terms of a complexity measure such as signaling latency or licenses or processing capacity available, to accept the UE to be attached. In step 6, an identifier of the physical MME entity may be passed to the virtual mobility manager entity 607 (VirtualStrataMME), which, in step 7, may contact the virtual mobility manager entity 607 which may run on the device identified at step 6. Then, the virtual mobility manager entity 607 may perform the signaling related to UE authentication, which is simplified as steps 9 and 10 in FIG. 6. However, this message exchange may involve the UE, which is not shown in FIG. 6. Eventually, and attach successful message may be relayed to the virtual management stratum in the UE in step 13 if the authentication sequence was performed without error. An error may be returned to the UE in case there were problems during authentication, which is not shown in FIG. 6.

FIG. 7 shows a simplified location update procedure with virtualized mobility management in the arrangement shown in FIG. 6. In particular, FIG. 7 shows a series of interactions between the virtual management strata when performing a location update procedure. The virtual management stratum 601 associated with the UE may transmit, in step 1, a location update request, wherein the virtual mobility manager entity 607 may receive the location update request in step 3 and ask the virtual topology manager entity 609 to determine which physical device, i.e. physical network entity, holds information about the UE. The virtual topology manager entity 609 may reply with the identifier of the device that holds the information, step 5, and the virtual mobility manager entity 607 instance running on this particular MME may contact the virtual mobility optimization entity 611. To determine whether to contact the virtual mobility optimization entity 611, the virtual mobility manager entity 607 may take into consideration criteria such as the signaling delay between the physical UE and the MME instance, the speed of the UE, the load on the MME instance, the physical distance between the two devices, the type of service subscription associated to the UE, etc. Then, the virtual mobility optimization entity 611 may determine whether the MME instance needs to be changed and, if so, virtual mobility optimization entity 611 may reply with the identifier of the new device, step 7. Then the virtual mobility manager entity 607, which may be running on the new MME instance, may perform the signaling related to the location update procedure within the infrastructure, which is shown simplified as steps 8, 9, 10 in FIG. 7. Eventually the result of the location update is communicated to the UE as e.g. a positive reply indicating a successful location update as shown in step 13 of FIG. 7.

Some embodiments described herein may be employed in Self-Organizing (SON) and Virtualized Mobility management approaches for future mobile networks. In this regard, the network architecture may be extended by a SON function being realized by the virtual management strata in order to further simplify mobility management. Thus, a mobile core network may be provided following the “infrastructure as a service” (laaS) paradigm.

According to some embodiments, the concept of the core network node pools may be extended into a virtual pool being formed by the virtual management strata wherein the redundancy and resiliency from the point of view of the mobile device may be augmented. A self-organizing solution may also eliminate the need for pool re-balancing operations and simplifies the management procedures.

According to some embodiments, in each mobility anchor, a part of the pool may implement the virtual management strata which may be in charge of accepting communications from e.g. eNodeBs, of resolving the real address of the mobility anchor that stores a particular user context, and of automatically copying contexts between mobility anchors within the pool in case a device is being shutdown, brought up from maintenance or overloaded. In this regards, a DHT-algorithm may provide for self-organization aspects inside the pool.

According to some embodiments, the UE does not need to be informed about the change of physical serving MME, so that a detach/attach procedure does not need to be performed so that services may not be interrupted. Therefore, S1 handovers may be avoided.

According to some embodiments, the virtualized mobility concept may be provided, which may reduce the signaling by removing the need for e.g. S1 handover procedures. In turn, radio resources may efficiently be used. Furthermore, the current pool-based solutions for mobility anchors may be simplified, therefore simplifying the management at the level of the eNodeBs or RNCs. This is due to the fact that only one or two connections may be configured in total, instead of one connection per device part of the pool. Furthermore, an increased resiliency of mobility management entities, an increased quality of service perceived by users e.g. in the ECM-CONNECTED state in the event of a scheduled maintenance of MMEs may be provided.

1-22. (canceled)

23. A method for managing communications of a physical network entity in an arrangement of physical network entities, the method comprising:
managing communications of the physical network entity in the arrangement of physical network entities using a virtual management stratum, the virtual management stratum being associated with the physical network entity.

24. The method of claim 23, wherein managing communications further comprises exchanging a communication message between the virtual management stratum and another virtual management stratum which is associated with another physical network entity of the arrangement of physical network entities.

25. The method of claim 23, further comprising the virtual management stratum:
receiving a communication message;
performing one of determining a physical network entity of the arrangement of physical network entities to which the communication message pertains and randomly selecting a physical network entity from the arrangement of physical network entities to determine a physical network entity for forwarding the communication message; and
initiating a forward of the communication message towards the determined physical network entity.

26. The method of claim 23, further comprising the virtual management stratum:
receiving a communication message requesting a transmission of certain information towards a user entity;
determining a physical network entity in the arrangement of physical network entities which has the certain context; and
initiating a forward of the communication message towards the determined physical network entity to initiate a transmission of the certain information towards the user entity.

27. The method of claim 23, further comprising the virtual management stratum maintaining connectivity between the physical network entity and another physical network entity in the arrangement of physical network entities.

28. The method of claim 23, further comprising the virtual management stratum initiating a forward of a communication message towards another physical network entity in the arrangement of physical network to request a transmission of certain information towards the physical network entity.

29. The method of claim 23, further comprising the virtual management stratum:
initiating a forward of a communication message towards another physical network entity in the arrangement of physical network entities, the communication message comprising network information indicating at least one of a network load and an availability of the physical network entity.

30. The method of claim 23, further comprising the virtual management stratum:
determining a physical network entity in the arrangement of physical network entities towards which certain information is to be transmitted upon the basis of a complexity measure; and
initiating a forward of the certain information towards the determined physical entity.

31. The method of claim 23, wherein the arrangement of physical network entities comprises a network control node, a network management node and a user entity, the network control node communicating with the network management node, the network management node managing communications of the user entity, the virtual management stratum being associated with the network management node, the virtual management stratum managing communications of the network management node with the network control node or with the user entity.

32. The method of claim 23, wherein the arrangement of physical network entities comprises a network control node, a network management node and a user entity, the network control node communicating with the network management node, the network management node managing communications of the user entity, the virtual management stratum being associated with the network control node, the virtual management stratum:
maintaining a first communication link between the network control node and a first network management node of the arrangement of physical network entities; and
maintaining a second communication link between the network control node and a second network management node of the arrangement of physical network entities, the second communication link forming a stand-by communication link for the first communication link.

33. The method of claim 23, wherein the arrangement of physical network entities comprises a network control node, a network management node and a user entity, the network control node communicating with the network management node, the network management node managing communications of the user entity, the virtual management stratum being associated with the user entity, the virtual management stratum initiating a transmission of an attach request towards a virtual management stratum of the network control node to request an establishment of a communication link over a communication network.

34. The method of claim 33, further comprising the virtual management stratum locally generating a global unique temporary identity (GUTI).

35. A physical network entity for communicating in an arrangement of physical network entities, the physical network entity comprising:
a processor being configured to provide a virtual management stratum associated with the physical network entity, the virtual management stratum being configured to manage communications of the physical network entity in the arrangement of physical network entities.

36. The physical network entity of claim 35, the virtual management stratum further comprising a virtual entry point entity for communicating with another physical network entity of the arrangement of physical network entities.

37. The physical network entity of claim 35, the virtual management stratum further comprising a virtual mobility manager entity for identifying another physical network entity for performing one of holding certain information, and for transmitting certain information towards another physical network entity in the arrangement of physical entities.

38. The physical network entity of claim 35, the virtual management stratum further comprising a virtual topology manager entity for maintaining connectivity between the physical network entity and another physical network entity.

39. The physical network entity of claim 35, the virtual management stratum further comprising a virtual mobility optimization entity for determining another physical network entity in the arrangement of physical network entities towards which certain information is to be transmitted upon the basis of a complexity measure, and for initiating a transmission of the certain information towards the determined physical entity.

40. The physical network entity of claim 35, wherein the physical network entity is a network management entity managing communications of a user entity in the arrangement of physical network entities.

41. The physical network entity of claim 35, wherein the arrangement of physical network entities comprises a network control node, a network management node and a user entity, the network control node communicating with the network management node, the network management node managing communications of the user entity, the physical network entity being the network control entity, the virtual management stratum comprising a virtual mobility proxy entity for managing communications between the network control entity and the network management node.

42. The physical network entity of claim 35, wherein the arrangement of physical network entities comprises a network control node, a network management node and a user entity, the network control node communicating with the network management node, the network management node managing communications of the user entity, the physical network entity being the user entity, the virtual management stratum being configured to initiate a transmission of an attach request towards a virtual management stratum of the network control node, the attach request requesting an establishment of a communication link over a communication network.

43. The physical network entity of claim 35, wherein the processor is configured to execute a computer-implemented process to provide the virtual management stratum.

44. A computer program product stored in a non-transitory computer readable medium for controlling a processor, the computer program product comprising software instructions which, when run on the processor, causes the processor to manage communications of a physical network entity in an arrangement of network entities to:
manage communications of the physical network entity in the arrangement of physical network entities using a virtual management stratum, the virtual management stratum being associated with the physical network entity.
